(19) United States
(12) Patent Application Publication
(10) Pub. No.: US 2012/0225242 A1
(43) Pub. Date: Sep. 6, 2012

(54) FELT-BASED PATCH, FELT-BASED PATCH MATERIALS FOR A SEWING DEVICE, AND METHOD FOR BONDING PATCHES TO ITEMS VIA LIQUID AND SPRAY ADHESIVES

(76) Inventor: Kangning Liang, Bartlett, TN (US)

(21) Appl. No.: 13/041,252

(22) Filed: Mar. 4, 2011

(51) Int. Cl. B32B 3/10; B32B 3/06; D05B 23/00; B32B 7/12; B32B 37/12; B32B 38/00; B32B 5/02; B32B 33/00

(52) U.S. Cl. 428/86; 442/326; 428/102; 428/95; 428/196; 156/60; 156/93; 112/475.08

(57) ABSTRACT

A composite, felt-based material includes a felt layer, a second material layer, and an adhesive layer which adheres the second material layer to the felt layer.

### BACKGROUND OF THE INVENTION

1. Field of the Invention

The invention relates to felt-based patch materials for a patch-making sewing device. The invention is particularly beneficial when used with a single-needle embroidery sewing device.

2. Description of Related Art

A single-needle embroidery sewing device is a convenient and cost-effective way to create and produce custom patterns on a patch material. A patch (or appliqué) produced by this and other sewing devices can be used to decorate various items, such as garments, hand bags, T-shirts, and many other objects. U.S. Pat. No. 6,814,014 discloses an example of a single-needle embroidery sewing device. Unlike common embroidery machines, a single-needle embroidery device does not provide a mechanism to form lock stitches or chain stitches on the underside of the patch. Instead, it produces one loop of the thread which hangs loosely from the underside of the patch material for each stitch that is made.

Due to the area density and relatively small thicknesses of previously used patch materials, the patches produced by various sewing devices are often of poor quality and significant deformation. This is frequently the case when conventional patch materials are used with single-needle embroidery sewing devices, where the number and density of the loops hanging from the underside of the patch material cause the patch to severely bend and deform. Single-needle embroidery sewing devices also produce uneven tension between the stitches of the topside and underside is uneven, which leads to further deformation of conventional patch materials, especially when a high density of stitches is required in the embroidery pattern. FIG. 1 shows how a typical patch material 101 is deformed by stitches of thread 102 made using a single-needle sewing device which creates thread loops 103 on the underside of the patch material 101.

In addition, the patterns themselves, formed on patches that are made without the use of any lock or chain stitches and have stitch loops hanging freely from the underside of the patch, are prone to deformation and unraveling. In particular, the tops of such patches often experience forces which pull on the thread patterns formed thereon, pulling some or all of the stitch loops from the underside of the patch to the top side of the patch.

Also, when such patches are attached to an item (e.g., garments, hand bags, T-shirts, etc.), the stitch loops on the underside of the patch (which are now pressed against the surface of the item) cause either the path or the item (or both) to buckle and deform since the stitch loops extend significantly from the underside of the patch.

Furthermore, previous methods for attaching patches to an item involve sewing the patch to the item. However, such a process can be time consuming and requires a significant amount of user skill. Also, not every item lends itself to such an attachment method (e.g., leather bags, lunch boxes, etc.).

Other methods for attaching patches to an item involve placing a solid thermoplastic adhesive film between the patch and the item, and applying a heat source (e.g., an iron) producing substantially elevated temperatures to melt the thermoplastic to both the patch and the item. However, this process poses several drawbacks. First of all, the “iron-on” method cannot be used with heat-sensitive receiving objects, as the elevated temperatures of this method would damage the receiving item. This method also cannot be used with objects having irregular, non-flat receiving surfaces, as thermoplastic film will not provide a uniform bond on such a receiving surface. Second of all, even when a receiving item with a regular, flat surface is used, it is still difficult to achieve uniform bonding, especially in the area underneath the pattern. Furthermore, the heat source usually must be applied directly to the top surface of the patch itself in order to allow for sufficient heat to reach and melt the thermoplastic. This often has the effect of damaging the top surface of the patch due to the amount of heat that must be used. For example, some of the stitching threads may soften or even melt, causing the pattern to have fused and flattened threads. In addition, use of such significantly elevated heat sources (such as a hot iron) pose a safety concern, especially in households with young children.

### SUMMARY OF THE INVENTION

To address the problems discussed above, a composite, felt-based material is provided which includes a felt layer, a second material layer, and an adhesive layer which adheres the second material layer to the felt layer.

Also provided is a patch which includes a felt layer, a second material layer which is adhered to the felt layer by a liquid or spray adhesive, and a thread which penetrates the felt layer and the second material layer.

An item is also provided. The item includes a first surface and a patch. The patch includes a fabric material, and is adhered to the first surface by a liquid or spray adhesive.

In addition, a method of forming a composite, felt based material is provided. This method involves applying an adhesive film between a layer of felt and a layer of a second material, so that the second material layer is adhered to the felt layer by the adhesive film.

A method of forming a patch is also provided. This method includes attaching a thread to a needle; and penetrating a patch material with the thread. In this method, the patch material includes a layer of felt, and a layer of a second material which is adhered to the felt layer by an adhesive film.

Also, a method of attaching a patch which includes a fabric material to an item is provided. This method includes applying a liquid or spray adhesive on a first surface of the item or a bottom surface of the patch (or a combination of the two), and pressing the patch against the first surface of the item, so that the patch is adhered to the item by the liquid or spray adhesive.

### BRIEF DESCRIPTION OF THE DRAWINGS

FIG. 1 shows deformation caused by stitching in a typical patch material;

FIG. 2 shows a cross-section of an embodiment of the current patch material with stitches passing therethrough; and

FIG. 3 shows a perspective view of the underside of an embodiment of a patch with stitching loops fixed to each other by a liquid or spray adhesive.

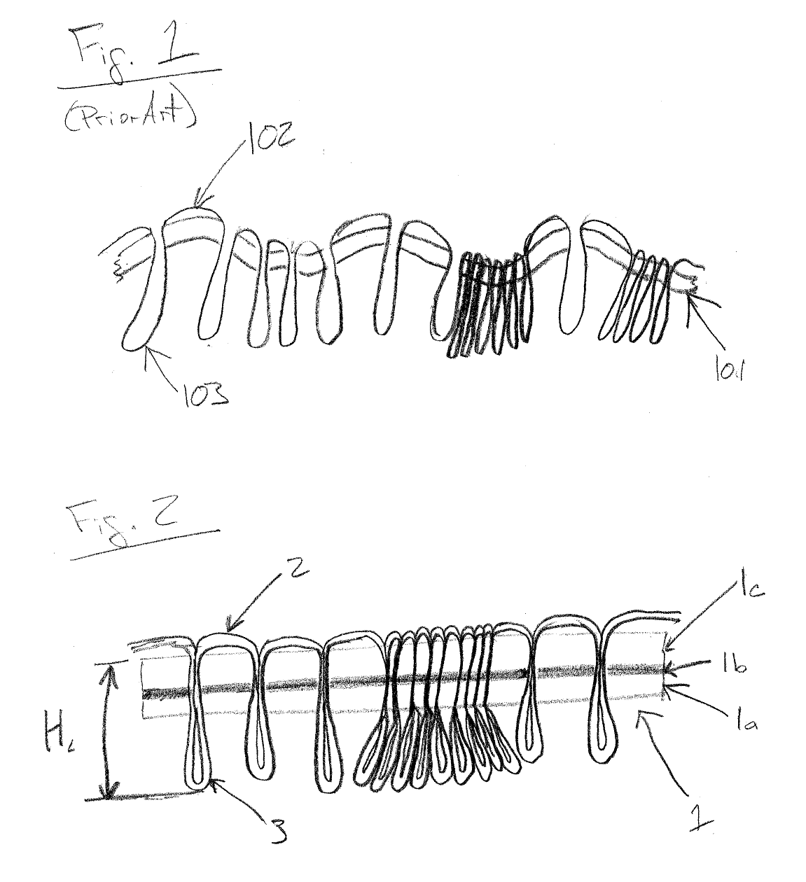

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

Patch Material:

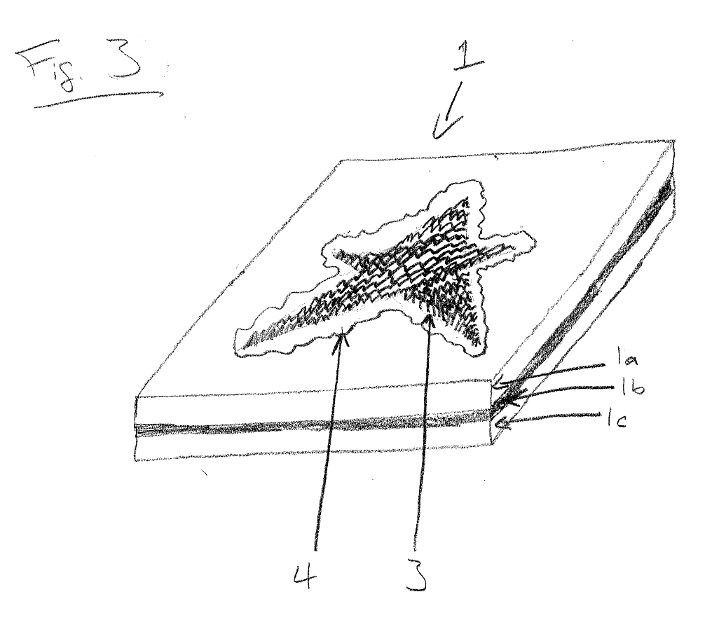

FIG. 2 shows an embodiment of a felt-based, composite patch material 1 of the current invention. The patch material 1 includes a layer 1a of felt, a layer 1c of a second material, and an adhesive layer 1b located between the felt layer 1a and the second material layer 1c which adheres the second material layer 1c to the felt layer 1a. The properties of the felt layer 1a and the adhesive layer 1b act to hold threads which pass through the patch material 1 better than the typical materials used to make patches. In addition, the properties of the felt layer 1a also act to prevent the patch deformation from which previous patch materials suffer.

By felt, what is meant is a nonwoven fabric made from a material which is matted together. Examples of materials which can be used to make felt include, but are not limited to, wool, fur, hair, and cotton, as well as synthetic materials typically used to make fabric (e.g., polyester, spandex, nylon, and such). Examples of processes used for matting that material together include, but are not limited to, the application of heat, application of moisture, and application of pressure to the material.

The two important factors which were discovered to affect the quality of the embroidered pattern for patch materials (particularly when used with single-needle embroidery sewing devices) are the area density and thickness of the patch material. In this case, these parameters (area density and thickness) are mainly determined by the type of felt chosen for the felt layer 1a. In order to prevent deformation of a patch, the patch material needs to have the capacity to absorb the space of the threads penetrating through it during the embroidery process. A sparse or modestly dense felt was found to have a large number of voids (space filled with air) was found to be particularly desirable, since these properties enables the felt to accommodate the stitches of thread 2 forming the embroidery pattern. Therefore, a felt-based patch material is able to improve expansion and consequently minimize the deformation of the embroidered patch.

In addition, the physical stiffness of a felt material can also reduce the impact caused by the uneven tension of the pattern.

Furthermore, with a single-needle embroidery process which generates a collective of thread loops 3 on the underside of the patch material 1, it is important to hide the collective bulkiness of the loops from being viewed or perceived when it is attached to an object. The sponge-like felt-based material has the ability to absorb and hide the bulkiness of the loops by taking advantage of the combination of large number of voids within the felt and the varying thickness of the felt.

The lack of underside lock stitches poses two issues with the patch: the control of stitch tension and the tendency of unraveling of stitches. One of the factors in controlling the stitch tension is tied to the extent of contact among the thread and fibers around it during the embroidery process. A felt-based patch material can positively affect the thread tension due to the random arrangement of the felt fibers, which allows better interaction between the thread and the felt fibers. The adhesive layer 1b can also enhance the thread tension by gripping the thread tighter when it penetrates the adhesive layer 1b. The adhesive layer 1b can be formed by a thin adhesive film including a thermoplastic material, a liquid and/or spray adhesive, and/or any other suitable adhesive material. It is preferred to use a spray adhesive (e.g., Elmer's® Spray Adhesive) to form the adhesive layer 1b, because a spray adhesive can prevent adhesive bleed-through on the felt layer 1a or the second material layer 1c.

Some physical characteristics of the felt used to make the patch material (such as the area density and thickness of the felt) are needed when considering some functions of the felt-stabilizing the pattern (e.g., hiding the bulkiness of the loops, and enhancing the tension of stitches). In order to have enough hiding and stabilizing power, the thickness of the felt, on the one hand, should at a minimum be comparable to the diameter of the embroidery thread. On the other hand, the felt thickness should not surpass the height H_{L} of the loops, which is measured from the top of the patch material (on which the embroidery patter is formed) the tip of the loop (extending from the underside surface of the patch material).

The diameter of the thread may vary depending upon the type of sewing or embroidery being done. For example, a relatively large diameter thread (“thick”) may be chosen if the pattern formed on the top of the patch is desired to be raised of have a noticeable texture. Conversely, if intricate or detailed embroidery is desired, a relatively small diameter thread (“thin”) may be chosen. A general thread size for all-purpose use is in the range of size 100 to 12. For the 50 WT Pacesetter™ 100% polyester thread from Brother, the diameter of the thread was measured to be around 0.06 mm.

Similarly, the desired height H_{L} of the loops may also vary. For example, it is generally desired to have loops with as small a height H_{L} as possible so as to facilitate attaching the patch to an item without having the loops cause either the item or the patch itself to deform. Conversely, the height H_{L} of the loops must be of a sufficient size so that the loops do not easily become pulled from the bottom of the patch through to the top of the patch, thereby unraveling the thread pattern formed on the top of the patch.

A number of factors cause the thread to be more or less securely held in the patch material. One such factor is how much the diameter of the thread can compress when squeezed by the patch material (through which the thread penetrates) and how much the diameter can expand again after the thread has passed through the fabric. The greater the thread can compress and expand, the more strongly the thread is held by the patch material and the shorter the loop height H_{L} needs to be. Similarly, the compression power/ability of the patch material is also a factor in how securely the thread is held. The greater the patch material can squeeze the thread (i.e., squeezing force), the more strongly the thread is held by the patch material and the shorter the loop height H_{L} needs to be.

Another factor for determining loop height H_{L} is the friction force applied by the thread surface (e.g., rough/smooth). The greater the friction force caused by the surface of the thread, the shorter the loop height H_{L} needs to be. Similarly, the friction force applied by the patch material itself also affects the required loop height H_{L}. The greater the friction force caused by the patch material, the shorter the loop height H_{L} needs to be.

Thus, relatively thick threads (with a relatively large compression and expansion property) which have a relatively large frictional force (e.g., rough texture), require shorter loop heights H_{L} compared to relatively thin threads (with a relatively small compression and expansion property) which have a relatively small frictional force (e.g., smooth texture). Similarly, patch materials with a relatively large squeezing force that apply a relatively large frictional force to thread which passes through the patch material, require shorter loop heights H_{L} compared to patch materials with a relatively small squeezing force that apply a relatively small frictional force to thread which passes through the patch material.

It has been determined that when the above properties and factors have been taken into consideration with respect to a felt-based, composite patch material 1, that the heights H_{L} of thread loops 3 preferably range from 0.5 mm to 4.0 mm, depending on the location and order of the stitch. Therefore, when a thread diameter of around 0.06 mm is used, the thickness of the felt layer 1a should preferably range from 0.06 mm to 2.0 mm, and more preferably range from 0.4 mm to 0.8 mm. The area density of the felt layer 1a preferably ranges from 0.1 g/in² to 0.2 g/in². Table 1 below lists examples various felts (along with their thicknesses and area densities) which fall into the preferred ranges above and result in good quality embroidery patterns.

TABLE 1
Parameters of Felts.

| Felt | Thickness (mm) | Area Density (g/in2) |
|---|---|---|
| #388082 | 0.67 | 0.121 |
| #894352 | 0.77 | 0.142 |
| #895169 | 0.54 | 0.106 |
| #893792 | 0.61 | 0.120 |
| #894311 | 0.44 | 0.119 |
| Ningbo felt | 0.65 | 0.173 |
| #881011 | 0.55 | 0.111 |
| #30681 | 0.62 | 0.154 |
| WM white | 0.73 | 0.141 |
| WM green | 0.62 | 0.111 |

The composition of the second material layer 1c may be chosen based on various considerations. For example, if the second material 1c layer has been decided to act as the top of the patch material (i.e., the side of the patch facing away from the item to which the patch is attached), then the composition of the second material layer 1c may be chosen based on its aesthetic properties to enhance the physical appeal of the patch. In such a case, the second material 1c may very well be chosen to be a material other than felt (e.g., a weave or other type of non-felt fabric).

The second material may also be chosen based on its durability, so that it acts to protect the underlying felt from the elements, daily wear and tear, and laundering. As such, the only absolute limits on the second material is that the second material must permit a sewing needle to pass through it when it is combined with a layer 1a of felt and an adhesive layer 1b to form a felt-based, composite patch material 1 as shown in FIG. 2.

In addition, the second material layer 1c may be a multi-layered fabric itself. For example, a tri-layered fabric comprised of a layer of loose cotton fibers (similar to felt), a layer of polyester fabric, and a thin layer of polyurethane, can be used as the second material layer 1c to form the felt-based, composite patch material 1.

Completed Patch:

While the improved patch material described above greatly reduces the risk of having stitches unravel, such unraveling is still a possibility with a patch that has unfixed loops of thread hanging freely from the bottom of the patch. The unraveling of a stitch often occurs during handling of it. Accidental pulling of a thread, especially the portion of the thread at the starting or the ending stitch, can reverse one or more stitches by dragging the segments of the thread on the underside back to the topside.

As shown in FIG. 3, in order to eliminate stitch unraveling, an adhesive 4 can be applied to the thread loops 3 to either bond them to the patch material 1, or form a network among the thread loops 3. In this case, a liquid adhesive (e.g., Dritz® Liquid Stitch, API™ Crafter's Pick™ The Ultimate! glue, etc.) or a spray adhesive (e.g., Elmer's® Spray Adhesive) can be applied to the loops 3 of the threads. Pressing the thread loops 3 with a flat object before the adhesive 4 is set serves to enhance the networking of the loops, as well as to reduce the overall thickness of the patch.

Affixing a Patch to an Item:

As an improved way to attach a patch to a receiving item, a water-based liquid adhesive (e.g., Dritz® Liquid Stitch) or a spray adhesive (e.g., Elmer's® Spray Adhesive) can be used to bond a patch to an object. It is best to apply the adhesive first to the underside of the patch and then apply the patch (adhesive side down) to the surface of the receiving object or item. While the adhesive may be first applied to the receiving item, extra care may need to be taken to ensure the adhesive does not bleed through the receiving item to too great a degree.

The type of bonding adhesive used to affix a patch to an item depends on how the end item or product is to be used. For example, in garment applications, some machine washing and drying is expected during the use of the patch. It was found that both Elmer's® Extra Strength Spray Adhesive and 3M™ Super 77™ enabled patches (including a felt-based, composite patch) to remain bonded to cotton T-shirts through at least one typical washing and drying cycle.

### Examples

Materials:

A thread with a thickness of 0.06 mm was used with a single-needle embroidery devices (Brother Appliqué Station E100 Computerized Sewing Machine).

Felts purchased from Hobby Lobby include white (#388082, thickness 0.67 mm, 0.121 g/in²), ivory (#894352, thickness 0.77 mm, 0.142 g/in²), gold (#895169, thickness 0.54 mm, 0.106 g/in²), white (#893792, thickness 0.61 mm, 0.120 g/in²), beige (#894311, thickness 0.44 mm, 0.119 0.111 g/in²), and white (#30681, thickness 0.62 mm, 0.154 g/in2). Felts purchased from Walmart: Fabric Crafts include Craft Felts (white, thickness 0.73 mm, 0.141 g/in2) and Rainbow Classicfelt (green, thickness 0.62 mm, 0.111 g/in2).

A weave fabric for use as a second material layer was purchased from Jo-Ann Fabrics and Crafts Store (white, thickness 0.37 mm, 0.135 g/in². A multi-layered fabric purchased from Hancock Fabrics: white (3% polyurethane-65% polyester-35% cotton) (thickness 0.37 mm, 0.135 g/in²).

Adhesives used include Elmer's® Spray Adhesive and Elmer's® Extra Strength Spray Adhesive (Elmer's® Products Inc., Columbus, Ohio), Dritz® Liquid Stitch (Prym Consumer USA Inc., Spartanburg, S.C.), API™ Crafter's Pick™ The Ultimate! glue (The Adhesive Products Inc., Albany, Calif.), 3M™ Super 77™ Multipurpose Adhesive (3M™ Corporate, St. Paul, Minn.).

Preparation of Felt and Patch Materials:

To test individual felt materials, the felt fabric was cut into a square of 3¼×3¼ in² to fit the hoop of the Appliqué Station E100.

A felt-based, compound patch material was prepared by bonding a felt to the multi-layered fabric or the Jo-Ann weave fabric with an adhesive. The adhesive was applied to the felt or the polyurethane surface of the tri-layered fabric and allowed to set at room temperature for 3 hours. The resulting patch material was then cut into a 3¼×3¼ in² to fit the hoop of the Appliqué Station E100.

In order to fully evaluate the quality of the felts and patch materials, one of the built-in patterns of Appliqué Station E100, the Rose pattern, was chosen because it is formed with very dense stitches. The process of forming the pattern is outlined in the operation manual.

Fixation of Stitches on the Underside of Patches:

Fixing the stitch loops on the underside of the patches was accomplished by applying an adhesive to the stitch loops on the underside of the patch and allowing the adhesive to set at room temperature. The adhesive links the loops into a network, effectively locking the stitches on the underside. This fixing step could be skipped if the patch is to be bonded to an item right away.

Attachment of Patches Using Adhesives

An adhesive was used to bond a patch to an object such as a garment in this work. The choice of adhesives is closely related to the application of the final product. Both a spray adhesive and a liquid adhesive (water-based or organic solvent-based) can be used. After bonding, the adhesive was allowed to set at room temperature for 3 hours or longer.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. A composite, felt-based material comprising:
a felt layer;
a second material layer; and
an adhesive layer which adheres the second material layer to the felt layer.

2. The composite, felt-based material of claim 1;
wherein the adhesive layer includes a thermoplastic material.

3. The composite, felt-based material of claim 1;
wherein the adhesive layer is formed by a liquid adhesive.

4. The composite, felt-based material of claim 1;
wherein the adhesive layer is formed by a spray adhesive.

5. The composite, felt-based material of claim 1;
wherein the second material layer includes a fabric.

6. The composite, felt-based material of claim 5;
wherein the fabric is a non-felt material.

7. A patch comprising:
a felt layer;
a second material layer which is adhered to the felt layer by a liquid or spray adhesive; and
a thread which penetrates the felt layer and the second material layer.

8. The patch of claim 7;
wherein the thread forms a pattern on a top surface of the patch in a shape of an image.

9. The patch of claim 7;
wherein the thread forms loops which extend from a bottom surface of the patch.

10. The patch of claim 9;
wherein the thread loops are fixed to each other by a liquid or spray adhesive.

11. An item comprising:
a first surface;
a patch which includes a fabric material and is adhered to the first surface by a liquid or spray adhesive.

12. The item of claim 11;
wherein the patch comprises:
a felt layer;
a second material layer which is adhered to the felt layer by a liquid or spray adhesive; and
a thread which penetrates the felt layer and the second material layer.

13. The item of claim 12;
wherein the thread forms a pattern on a top surface of the patch in a shape of an image.

14. The item of claim 12;
wherein the thread forms loops which extend from a bottom surface of the patch.

15. The item of claim 14;
wherein the thread loops are fixed to each other by a liquid or spray adhesive.

16. A method of forming a composite, felt based material, the method comprising:
providing a layer of felt;
providing a layer of a second material;
applying an adhesive film between the felt layer and the second material layer, so that the second material layer is adhered to the felt layer by the adhesive film.

17. The method of claim 16;
wherein the adhesive film includes a thermoplastic adhesive.

18. The method of claim 16;
wherein the adhesive film includes a liquid adhesive.

19. The method of claim 16;
wherein the adhesive film includes a spray adhesive.

20. A method of forming a patch, the method comprising:
attaching a thread to a needle; and
penetrating a patch material with the thread;
wherein the patch material comprises:
a felt layer;
a second material layer which is adhered to the felt layer by an adhesive film.

21. The method of claim 20;
wherein the thread penetrates the patch material so as to form a pattern on a top surface of the patch material in a shape of an image.

22. The method of claim 20, further comprising:
forming loops of the thread which extend from a bottom surface of the patch material.

23. The method of claim 22, further comprising:
fixing the thread loops to each other by a liquid or spray adhesive.

24. A method of attaching a patch which includes a fabric material to an item, the method comprising:
applying a liquid or spray adhesive on a first surface of the item; and
pressing the patch against the first surface of the item, so that the patch is adhered to the item by the liquid or spray adhesive.

25. The method of claim 24;
wherein the patch comprises:
a felt layer;
a second material layer which is adhered to the felt layer by an adhesive layer; and
a thread which penetrates the felt layer and the second material layer, the thread forming a pattern on a surface of the patch in a shape of an image.

26. The method of claim 24;
wherein the thread forms loops which extend from a bottom surface of the patch.

27. The method of claim 26, further comprising:
fixing the thread loops to each other by applying a liquid or spray adhesive to the thread loops before the patch is pressed against the first surface of the item.

28. A method of attaching a patch which includes a fabric material to an item, the method comprising:
applying a liquid or spray adhesive on a bottom surface of the patch; and
pressing the bottom surface of the patch against a first surface of the item, so that the patch is adhered to the item by the liquid or spray adhesive.

29. The method of claim 28;
wherein the patch comprises:
a felt layer;
a second material layer which is adhered to the felt layer by an adhesive layer; and
a thread which penetrates the felt layer and the second material layer, the thread forming a pattern on a top surface of the patch in a shape of an image.

30. The method of claim 28;
wherein the thread forms loops which extend from a bottom surface of the patch.

31. The method of claim 30, further comprising:
fixing the thread loops to each other by applying a liquid or spray adhesive to the thread loops before the patch is pressed against the first surface of the item.
